(19) United States
(12) Patent Application Publication
(10) Pub. No.: US 2008/0086678 A1
(43) Pub. Date: Apr. 10, 2008

(54) SYSTEM AND METHOD FOR PREPARING DISTRIBUTABLE MULTIMEDIA PRESENTATIONS OVER THE INTERNET

(75) Inventors: Diane Marie Herzman, Bronxville, NY (US); George V. Gaunt, Mahopac, NY (US)

Correspondence Address: OSTROLENK FABER GERB & SOFFEN, 1180 AVENUE OF THE AMERICAS, NEW YORK, NY, 100368403, US

(73) Assignee: BUSINESS HELPERS INCORPORATED, Bronxville, NY (US)

(21) Appl. No.: 11/836,999

(22) Filed: Aug. 10, 2007

Related U.S. Application Data
(60) Provisional application No. 60/822,114, filed on Aug. 11, 2006.

(51) Int. Cl. G06F 17/00

(52) U.S. Cl. 715/201

(57) ABSTRACT

The invention includes a system and method for creating, displaying and searching for a multimedia presentation over a communication network Multimedia presentation modules are stored on an information processor that enable users to select options associated with the multimedia presentation. Further, an internet web site is hosted on the information processor, and the internet web site includes restricted and unrestricted access for users. Further a user defines a multimedia presentation by selecting a template provided by an information processor. The user further defines at least image and text components to be included in the multimedia presentation, by selecting from the information processor or uploading to the information processor the image and/or textual components. The information processor generates the multimedia presentation, and stores the multimedia presentation. A message is transmitted to a recipient enabling the recipient to access the multimedia presentation using at least one of a web browser software application, an e-mail software application or a cellular telephone. Further, an interface is provided on the information processor enabling the user or other users to search for, locate and view the multimedia presentation.

### CROSS-REFERENCE TO RELATED APPLICATIONS

The present patent application is based on and claims priority to U.S. Provisional Patent Application Ser. No. 60/822,114, filed on Aug. 11, 2006, and entitled “SYSTEM AND METHOD FOR PREPARING DISTRIBUTABLE MULTIMEDIA PRESENTATIONS OVER THE INTERNET,” the entire contents of which are incorporated by reference.

### BACKGROUND OF THE INVENTION

1. Field of the Invention

The present patent application is related, generally, to digital multimedia creations, and, more particularly, to a tool for providing multimedia content over a communication network, such as the Internet.

2. Description of the Related Art

Enrollment in degree-granting institutions is increasing annually and dramatically. Between 1994 and 2004, enrollment increased at a rate of 21%, and trends indicate that this percentage will increase. Once a degree from an academic institution is earned, students are challenged to enter the job market and begin earning a living. In the search for a job or career path, it is believed that students generally do not attend job fairs or read expensive school ads. Instead and more typically, students check their school's career development web page regularly to receive information regarding employment possibilities.

Currently, it is estimated that in today's job market over nine hundred job applicants can compete for a single job. A challenge for each applicant is to create a new and distinctive way to present one self. Job resumes remain a very common tool for providing information about ajob candidate. It is believed, however, that resumes fail to provide a distinctive presentation, especially for an administrator who has the daunting task of reviewing over nine hundred resumes for a single job position.

Further, virtually every student has access to or owns a cellular telephone, and it is estimated that close to half of cellular telephone users send and receive text messages and take images (stills or moving), almost a quarter access internet web pages, and over three-quarters keep the phone on all the time and personalize their ring tones. Thus, in addition to becoming a staple product, the cellular telephone has evolved into a fashion accessory.

Thus, cellular telephones have become an integral and/or essential communications tool that has altered the way users spend their time. Beyond simply talking on the telephone, users of cellular telephones have become more spontaneous and prolific in their communication patterns. Further, it is likely that the behavior of cellular telephone users will intensify in coming years as more people become attached to, and reliant upon, their mobile phones.

It is believed that presentations that do not contain moving images and/or audio data are quickly forgotten. One reason may be that many people remember what they see and hear, and not so often what they read. Currently, MICROSOFT POWERPOINT presentations can be formatted to include still images, audio, animation and/or video material. However, inclusion of such objects causes POWERPOINT presentations to grow significantly in byte size. Although the number of Internet users with broadband internet access (e.g., DSL and cable access) continues to grow, the majority of people still access the Internet via dial-up Internet connections at much slower speeds than those provided by broadband connections. Large presentation files, such as described above, can delay the process of downloading significantly, especially for those users accessing the Internet via dial-up connection.

Further, in order to view a POWERPOINT presentation file, a software application (e.g., the POWERPOINT viewer) must be installed on any PC (or MACINTOSH) computer that does not have a copy of MICROSOFT POWERPOINT installed. Since the price of POWERPOINT is often prohibitive for many computer users, particularly students, an alternative application such as the POWERPOINT viewer is necessary to view the presentation file. The currently available version of the POWERPOINT viewer supports presentations formatted for versions of MICROSOFT POWERPOINT 97 and later, thereby raising the issue, described above, with respect to the version of POWERPOINT with which a particular presentation is created. Another shortcoming of the POWERPOINT viewer is that it is almost two megabytes in size, which may be prohibitive for downloading for users of slow (e.g., dial-up) Internet connections.

Moreover, users are reluctant to download and install anything on their computers due to the outbreak of viruses. POWERPOINT has been known to be vulnerable to virus attacks. MICROSOFT has posted on its Internet web site antivirus technical support specifically for POWERPOINT presentations. Thus, there is a concern among computer users that POWERPOINT presentation files may be infected with a malicious virus.

U.S. patent application Ser. No. 11/145,915 (the “'915 patent application”), and commonly assigned as the present patent application, defines a system and method for providing a multimedia presentation for distribution over communication networks that includes defining a first multimedia presentation comprising text and audio components, wherein the first presentation has a first file size and is viewable using a first presentation software application. The '915 patent application further defines isolating the text and audio components included in the first multimedia presentation. Further, a second multimedia presentation is defined in the '915 patent application and the isolated text and audio components are provided into the second multimedia presentation. Furthermore, in a preferred embodiment, a user transmits a message to a recipient that enables the recipient to access the second multimedia presentation. The second multimedia presentation is preferably accessible using web browser software and/or e-mail software, and the second multimedia presentation appears substantially the same as the first presentation file. Furthermore, the second multimedia presentation has a smaller file size than the first multimedia presentation file. Thus, the '915 patent application is directed, among other things, to efficiently sizing presentations for distribution. In the prior art, no system or method is taught for providing multimedia presentations as taught by the '915 patent application using an information processor over a communication processor, such as the internet.

As the number of people communicating over a publicly accessible communication network, such as the internet, continues to grow, the number of transmissions of large files containing formatted information, such as formal presentations and other formatted works, proportionally grows as well, including over cellular telephones. Millions of people have various needs for transmitting multimedia presentation files that contain elaborate formatting of information in order to capture the attention of recipients or individuals viewing the files.

### SUMMARY

A need exists for a tool that highlights personal achievements and professional accomplishments. A need also exists that sets one job candidate apart from the hundreds, if not thousands, of other candidates when competing for a specific job. Further, a need exists for a multimedia presentation tool that provides fast delivery, manageable file size, and platform independence, for example, to accommodate personal computers equipped with varying operating systems, such as MS-WINDOWS, MAC OS X, AND LINUX.

Preferably, a digital communication platform is used and is, therefore, attractive to contemporary student bodies. For example, users of the present can access and use the features described herein via a cellular telephone. Systems and methods described herein preferably include a tool that highlights and displays personal achievements and professional accomplishments.

### BRIEF DESCRIPTION OF THE DRAWINGS

FIG. 1 illustrates an example hardware arrangement, in accordance with an embodiment;

FIG. 2 is a block diagram illustrating the functional elements in an example information processor;

FIG. 3 is a diagram that illustrates parties that are associated with an embodiment and preferably communicate via one or more web sites hosted by an information processor in accordance with a preferred embodiment;

FIG. 4 is a diagram that provides a more detailed illustration of relationships of parties and business illustrated in FIG. 3 and in accordance with a preferred embodiment;

FIG. 5 illustrates an example hardware arrangement in connection with various devices and for providing and receiving multi-media presentations in a preferred embodiment;

FIG. 6 is a diagram that illustrates programs and options available to schools in accordance with a preferred embodiment;

FIG. 7 shows parties and relationships available to companies in accordance with a preferred embodiment;

FIG. 8 is a block diagram that illustrates an example site map associated with a web site in accordance with a preferred embodiment;

FIG. 9 is a block diagram that illustrates example steps associated with creating a multi-media presentation in accordance with a preferred embodiment;

FIG. 10 is a flow chart that illustrates example steps associated with saving and ordering the multimedia content in accordance with a preferred embodiment;

FIG. 11 illustrates example options and corresponding steps associated with authorized users accessing information processor;

FIG. 12 is a flowchart that illustrates example steps associated with upgrading a user account;

FIG. 13 is a flow chart that illustrates example steps S400 associated with viewing a multimedia presentation in accordance with a preferred embodiment; and

FIG. 14 illustrates example web pages and multimedia presentations generated and distributed in accordance with a preferred embodiment.

### DESCRIPTION OF THE EMBODIMENTS

In a preferred embodiment, a centralized, on-line and easily accessible tool is provided for users to develop and distribute multi-media presentations, such as in accordance with those described in the '915 patent application.

In a preferred embodiment, multi-media resume's are provided in an electronic, self-explanatory and substantially automatic way to collect information representing a summary of one's achievements to be presented in a presentation format intended to separate the message and its delivery format from competition. Further, one or more templates are preferably provided for a user to define a look and feel of a presentation.

As used herein, the term, “module,” refers, generally, to one or more discrete components that contribute to the effectiveness of the systems and methods described herein. Modules can include software elements, including but not limited to functions, algorithms, classes and the like. Modules also include hardware elements, substantially as described below. Modules can operate independently or, alternatively, depend upon one or more other modules in order to function.

Preferably, a user registers with a proprietor of an information processor providing modules described herein, for example, by paying a fee and/or by completing a data entry form. Thereafter, the registered user is provided with information for on-line access, such as a secured uniform resource locator (“URL”) that is accessible by the user for a period of time, such as one year and that may be renewed for additional periods, such as annually.

In a preferred embodiment, an electronic repository of networked information is provided via an internet web site that stores various software-related applications comprising interactive, video and voice-narrated content, including résumés and presentations. The functionality of the software applications improves upon prior art methods for hiring people and revolutionizes the way applicants locate employment. The repository is specifically designed to enhance the recruiting practice of companies, enabling companies to show how they can effectively present themselves to attract serious career-minded applicants. As shown in the drawings and occasionally used herein, the trademarked name, “RES-A-VUE.COM,” refers to an example internet web site providing the systems and methods shown and described herein, and preferably hosted on an information processor.

Further and as described herein, a virtual dedicated network is defined to deliver to users a complete package of data that are particularly indigenous to employment or recruiting processes. In an embodiment, a user establishes a communication session with an internet web server that hosts a web site, for example, by submitting an authorized user name and password, and, effectively logs in to reach one or more of a plurality of parties associated with employment, including, for example, university and college students, career-oriented graduates, employment agencies, companies, schools, university and college career services departments, or a student-to-student exchange-of-information platform, referred to in the corresponding drawings as “My Place.”

In one embodiment, other parties, such as head-hunters, employment agencies, companies and educational institutions are associated with the virtual dedicated network, including the internet web site to further prospects for locating candidates for job placement. Preferably, one or more electronic libraries of resources are preferably provided and/or supported for major corporations or recruiting firms. For example, human resource information is stored in libraries catalogued by employee specialty, promotion track, attributes, geographic preference, grade level, personal goals/achievements/objectives. Also, head-hunters, employment agencies or the like are preferably given access to various' categories of users. For example, a sophisticated and automated approach for intermediate users is also provided. In a preferred embodiment, an intermediate user is anyone other than a college student including but not limited to alumni of any participating school. As used herein, an intermediate user is applied to job seekers already in the work place either looking to upgrade their employment or seek replacement positions.

Moreover, elite members, for example, students who meet strict criteria are preferably listed, are listed and represent one- to five percent of all students who are users of the systems and methods described herein and are from various universities and colleges are preferably featured on the web site.

Preferably, narrated multi-media presentations are provided and supported that are brief (for example, 8 to 60 seconds) and preferably delivered via e-mail to a computer, PDA or cell phone. Students review the presentations and respond because the presentations are direct, personal and easy to use, and take the impersonal out of web recruiting. Companies can be promoted, including by highlighting respective cultures, benefits and specialties, as well as to add a contact source for that “one-on-one” personal touch, target their specific needs, such as by school. Further, the presentations are easily updated regularly, and automatic electronic notifications are sent to job mart inquiries, and providers are electronically advised when a presentation has been accessed, searched for, or the like.

In practice, a registered user preferably uses an on-line tool provided by an information processor to submit information, for example, regarding his/her personal and/or professional achievements, and the system compiles automatically a presentation, such as in the form of a resume and/or portfolio(s), and that includes audio/visual message content, which is preferably printed in high resolution. Preferably, any text provided can be edited during the period of time while a user is registered. In one business method, no additional fees are charged to the user for editing/adding text, although fees may be charged for adding/editing an audio segment, such as a voice segment.

In one embodiment, a global executive search engine is defined for large and small employers across many industries and continents. It is preferably designed to support international job seekers and professionals with a large assortment of original country-specific career information. Content and links preferably provide users with a comprehensive tool kit for evaluating, selecting and transitioning into a successful career in a foreign country. Moreover, resume writing advice is preferably provided, as well as access to job sources, work permits and visa regulations, cultural advice for a multitude of countries.

Thus, as is evident to one skilled in the art, a novel business method is provided by the systems and methods herein for recruiting for senior level candidates, middle management and college-graduate positions. Preferably, a fee-based arrangement is defined for recruiters and client-users and not for college students. In one embodiment, a “basic” version (without many options) is provided free of charge to college students associated with a college or university who access various modules provided on information processor 12. Candidates from an intermediate group are preferably charged a fee. Further, candidates for a professional profiles section and executive Achievement Summaries, however, are responsible for the preparation of their material, and, accordingly, may further be charged a fee to be placed in a section on a web site associated with professional profiles section. Thus, for example, professionals who are seeking to locate new employment may be charged a fee to promote their previous professional accomplishments.

Moreover, a business method that is provided in three levels: an entry level, an intermediate level and an executive level. The entry level is preferably provided for parties such as students, interns, and/or graduate students who may or may not have portfolios. The entry level provides a simple to use, fully automated interface. The intermediate level may include certain features that are automated, and some features that are otherwise manually executed in order to provide increased control over the way content is provided and managed. The executive level includes very few, if any, automated features and is preferably provided for users to generate presentations, such as described in the '915 patent application. The presentations are preferably completed in the “MARKET-VUE.COM” processes and may be provided with names, such as “Career Profile Plan” and “Executive Achievement Summary.”.

In one embodiment, users are assigned a URL and storage space on an internet web server which can be accessed by non-registered users to view and/or listen to a presentation developed by the registered user. This enables parties to access a registered user's presentation, for example, simply via standard web browsing software and an internet connection.

In another embodiment, a voice response feature is provided that, for example, is operative using a telephone. In this embodiment, registered users preferably dial a toll free telephone number, submit a password (e.g., using keys on a touch tone telephone or speaking a password) and record a message that can become part of the user's presentation. Standard editing features are available, such as rewind, fast forward, start over, or the like. Once a user is satisfied with a recording, the recording is provided in a known format, such as a .wav format or .mp3 format, and the user can access recording via an internet web page, for example, to download and/or listen to the recording. This feature provides additional automation and precludes a requirement of a user to be equipped with a microphone or other device to record audio on a computer.

Thus, using the systems and methods described herein, college students, interns, graduates with or without a portfolio can create their own multi-media presentations on-line and over the internet using standard internet browser software and multimedia devices, such as a microphone that connects to an input of a computer sound card. Preferably, a self-contained, automated, online system is provided whereby users select choices from a series of templates to personalize their own presentations which can then be e-mailed anywhere, at any time, for example, with a resume and/or portfolio(s) attached. Both the development of the personalized rendition of the product and its delivery is preferably done via computer.

Preferably, a new, powerful digital marketing tool is provided for today's world of instant communication that is flexible, efficient, and is relatively small in size. In an embodiment, a multimedia presentation is distributed via e-mail and/or via an Internet web site. As described in detail below, presentations provided by the systems and methods described herein are preferably reformatted from an initial large, prohibitive size to a smaller and more manageable size. Further, the presentations are designed to be relatively short, for example sixty seconds.

Through extensive research, the inventors have combined and adapted features of prior art computer software in order to produce a presentation tool in accordance with the teachings herein. Preferably, multiple applications, for example, job résumés, business marketing and other forms for dispersing formatted information are provided. More particularly, method for delivering multimedia messages in an interesting audio-visual way, and also within a short, e.g., 60 seconds time period is provided. Moreover, sophisticated tracking is preferably utilized to gather data to help users or decision makers make timely decisions. Yet another feature includes a flexible medium that maximizes transmission speed of and quantity of information, all of which are considered key benefits that distinguish the systems and methods from the prior art.

In example embodiments, résumés are provided in electronic form, to showcase businesses or new business developments, to highlight designs, new products, portfolios, architectural schematics, and/or to aid in job-seeking and recruitment. Other example embodiments include providing portfolio displays, videos and design presentations that showcase lighting, fashion, typefaces, landscaping, structural design, color, architectural or engineering feats, interior design, sculpture, art, photography, graphics, and for theatrical experience.

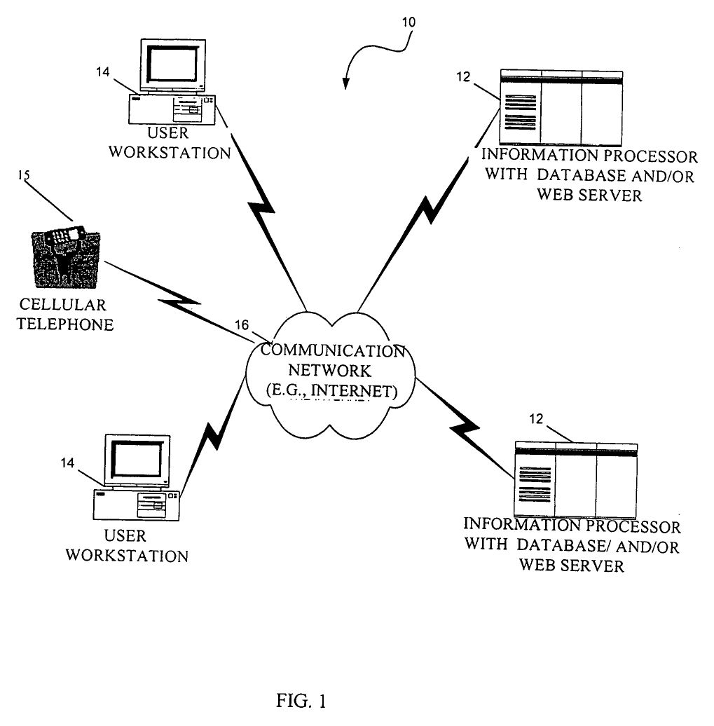

Referring to the drawing figures, in which like reference numerals represent like elements, FIG. 1 illustrates an example hardware arrangement, in accordance with an embodiment, for transmitting presentation file over a communication network, and referred herein, generally, as system 10. In the example shown in FIG. 1, information processor(s) 12 are operable to function as internet web servers, as known to those skilled in the art. Information processor preferably stores interactive, video and voice-narrated resumes and presentations, including templates therefore for efficient and convenient construction. Information processor 12 preferably includes all databases necessary to support the systems and methods provided herein. However, it is contemplated that information processor 12 can access any required database via communication network 16 or any other communication network to which information processor 12 may be coupled. Communication network 16 is preferably a global public communication network such as the Internet, but can also be a wide area network (WAN), local area network (LAN), or other network that enables two or more computers to communicate with each other.

In a preferred embodiment, information processor 12 and user workstation 14 are any devices that are capable of sending and receiving data across communication network 16, e.g., mainframe computers, mini computers, personal computers, laptop computers, a personal digital assistants (PDA), cellular telephones and Internet access devices such as Web TV. In addition, information processors 12 and user workstations 14 are preferably equipped with web browser software, such as MICROSOFT INTERNET EXPLORER, MOZILLA FIREFOX, or the like. Information processors 12 and user workstations 14 are coupled to communication network 16 using any known data communication networking technology. FIG. 1 further illustrates cellular telephone 15, which is preferably used to send and receive electronic information, such as multimedia content, via communication network 16. Although cellular telephone 15 is illustrated separately from user workstation 14, it is to be appreciated by one skilled in the art that cellular telephone 15 is operable as workstation 14.

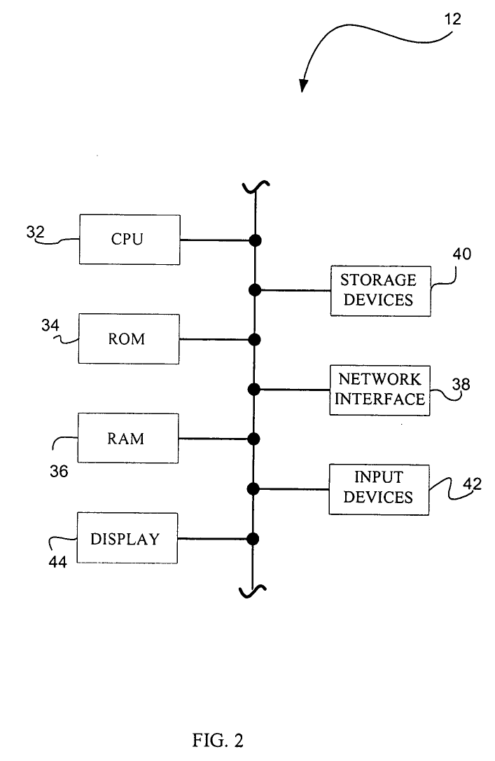

FIG. 2 illustrates the functional elements of an example information processor 12, and includes one or more central processing units (CPU) 32 used to execute software code and control the operation of information processor 12. Other elements include read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code databases and application data, one or more input devices 42 such as a keyboard, mouse, track ball, microphone and the like, and a display 44.

The various components of information processor 12 need not be physically contained within the same chassis or even located in a single location. For example, storage device 40 may be located at a site which is remote from the remaining elements of information processor 12, and may even be connected to CPU 32 across communication network 16 via network interface 38. Information processor 12 preferably includes a memory equipped with sufficient storage to provide the necessary databases, forums, and other community services as well as acting as a web server for communicating hypertext markup language (HTML), Java applets, Active-X control programs or the like to user workstations 14. Information processors 12 are arranged with components, for example, those shown in FIG. 2, suitable for the expected operating environment of information processor 12. The CPU(s) 32, network interface(s) 38 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within a web browser software display. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of information processor 12 shown in FIG. 2 are of the same categories of functional elements present in user workstations 14. However, not all elements need be present in the user workstation 14. For example, storage devices, in the case of PDA's, and the capacities of the various elements are arranged to accommodate the expected user demand. For example, CPU 32 in user workstation 14 may be a smaller capacity CPU than the CPU present in the information processor 12. Similarly, it is likely that the information processor 12 will include storage devices of a much higher capacity than storage devices present in user workstation 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL, PHP and a plurality of web site development applications.

Although the systems and methods are described by way of example herein and in terms of a web-based system using web browsers and a web site server (e.g., information processor 12), system 10 is not limited to such a configuration. It is contemplated that system 10 is arranged such that user workstation 14 communicates with and displays data received from information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 12 and user workstation 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on information processor 12 and user workstation 14 regard the process of communicating data across communication network 16 and processing the data such that the data is viewed on a display 44, for example by using a web browser and the like. As is common with web browsing software, the display 44 on user workstation 14 presents sites within the system 10 such that a user can proceed from site to site within the system by selecting a desired link.

Therefore, each user's experience with system 10 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

Preferably, the web site(s) and database(s) maintained by information processor 12 provide a network supporting career recruiting and locating needs. Preferably, a search engine is provided enabling users to access a searchable online database of resources, including multiple directories of a collection of information which is indexed and catalogued so users can search the entire system for specifics using keywords. Preferably, sections are cross-referenced to allow users to retrieve the material they seek that may be provided from many different groups of users or sources.

As noted above, a brief (e.g., 30 to 40 seconds) electronic, self-narrated audio-visual summary is preferably generated in accordance with the teachings herein, and delivered to a recipient, such as via e-mail or cell phone. The audio-visual summary is beneficial in that it is unique as well as an extremely effective communication technique that preferably includes one or more interactive links, a personal URL address, video options, and the capacity to include a resume and/or portfolio. Accordingly, students, interns and graduate school applicants access information processor 12 to create their own affordable, personalized presentations quickly (e.g., in less than one hour). Since users access information processor 12 remotely over the internet, the users can create and transmit presentations from virtually anywhere in the world.

Moreover, the web site(s) and database(s) provided by information processor 12 can be used, for example, to maintain current communications, such as to schedule and automatically send an interviewer a personalized “thank you” note even moments after an interview. Other automated functionality is preferably provided, such as automatic tracking, for example, alerting a user with an automatic electronic notification that an electronic presentation (e.g., a resume) stored in a database maintained by information processor 12 has been accessed.

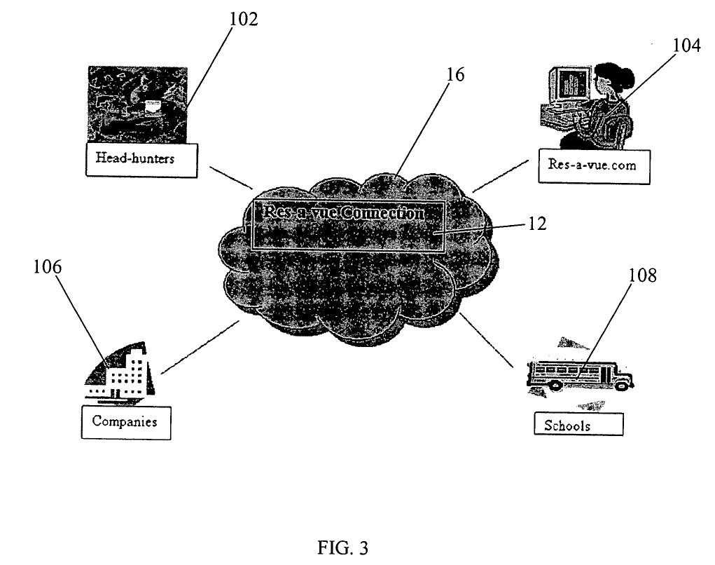

Preferably, several classes of users are envisioned, and the web site(s) and/or database(s) provided by information processor 12 are preferably designed with respective messages directed towards different audiences, including students, professionals, designers, executive profiles, electronic employee libraries or the like. FIG. 3 is a diagram that illustrates a plurality of parties that are associated with the systems and methods described herein and preferably communicate via one or more web sites hosted by information processor 12. As shown in FIG. 3, headhunters 102, job-seekers 104 (e.g., students), companies 106 and schools 108 establish communication sessions with information processor 12 over network 16, during, for example, job seeking or job placement-related activities. Preferably, users submit a user name and password for secured access to information processor 12 and corresponding databases and/or web site(s) provided or maintained thereby. Moreover, the web site(s) provided on information processor 12 (e.g., the RES-A-VUE site) preferably includes user-friendly programs, such as a “Tips and Guidance Section,” for students 104.

Preferably, users 102, 104, 106 and 108 access databases and web site(s) that are securely provided on information processor 12. The databases and web site(s) enable the users to identify and implement creative solutions to employment problems, such as to locate quality employment positions and qualified candidates. The users are preferably trained and supported in the components they have an interest in, thereby enabling them to become alert to industry changes as well as to remain flexible to implement those changes effectively and productively.

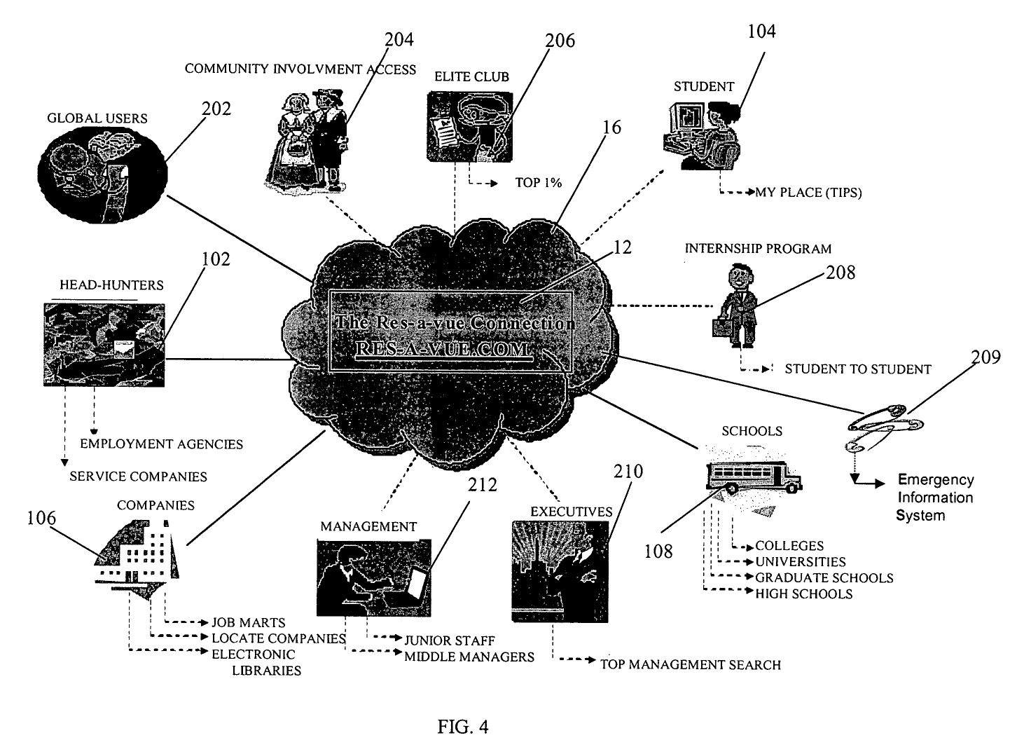

FIG. 4 is a diagram that provides a more detailed illustration of relationships of parties and business associated with information processor 12. As shown in FIG. 4, global users 202 represent job seekers and providers, such as students, who access web site(s) on information processor 12 from remote areas of the world. The global nature of the invention, as well as the various features provided therein, ensure users have involvement in a community 204, including community relationships through information processor 12. By encouraging local businesses to recruit students for part-time, full-time or internship programs via the businesses' respective web-sites, colleges and universities can take advantage of lines of communication within the community 204. This communication can be easily tied to community projects such as Toys for Tots, Blood Drives, or the like.

Continuing with reference to FIG. 4, elite club members section 206 enables learning institutions (e.g., colleges and university) to showcase the top one percent of their student body. This provides a major marketing tool to promote the popularity and scholastic level of a respective learning institution. Further, internship program 208 provides students who work hard and apply themselves employment opportunities via the web site provided by information processor 12. Accordingly, students can increase the likelihood of obtaining employment that may otherwise have been unavailable and, further, to develop their careers. Accredited college internship program 208 is provided, for example, to provide “earn as you learn” incentives and enabling students to earn money while learning on a job. Moreover, internship program 208 is inherently promoted, such as by student-to-student communications.

Continuing with reference to FIG. 4, emergency information system program 209 is provided that preferably promotes safety within school environments. In a preferred embodiment, emergency information system program 209 connects faculty, students, relevant authorities and parents in a substantially in real-time, such as if or when a particular safety need arises. Emergency information system program 209 plays a significant role in the safety of students and is a powerful tool to use to relate unexpected events, updates and professional reassurances to parents and faculty.

Continuing with reference to FIG. 4, executives 210 preferably access information processor 12 to send/receive multi-media presentations, as well as to search database(s) supported by information processor 12. Executives 210 are able to perform searches for top management personnel using modules provided by information processor 12. Moreover, management personnel 212 access information processor 12 to locate, among other things, middle management and junior management personnel. Also, companies 106 access information processor 12 to generate, send and receive communications regarding job marts, to locate companies and/or to post and review entries on electronic libraries.

Thus, a plurality of users are envisioned, including individuals (e.g., university and college students, career-minded applicants, professionals, executives), companies (e.g., recruiting firms, attendees and/or promoters and providers of job marts and providers of electronic libraries), professional agencies (e.g., head-hunters, employment agencies and service businesses), schools (e.g., colleges, universities, graduate schools, high schools and community liaisons) and social networking (e.g., student exchange-of-information platform, tips, internships and elite clubs) are networked together and access information processor 12 in accordance with the teachings herein.

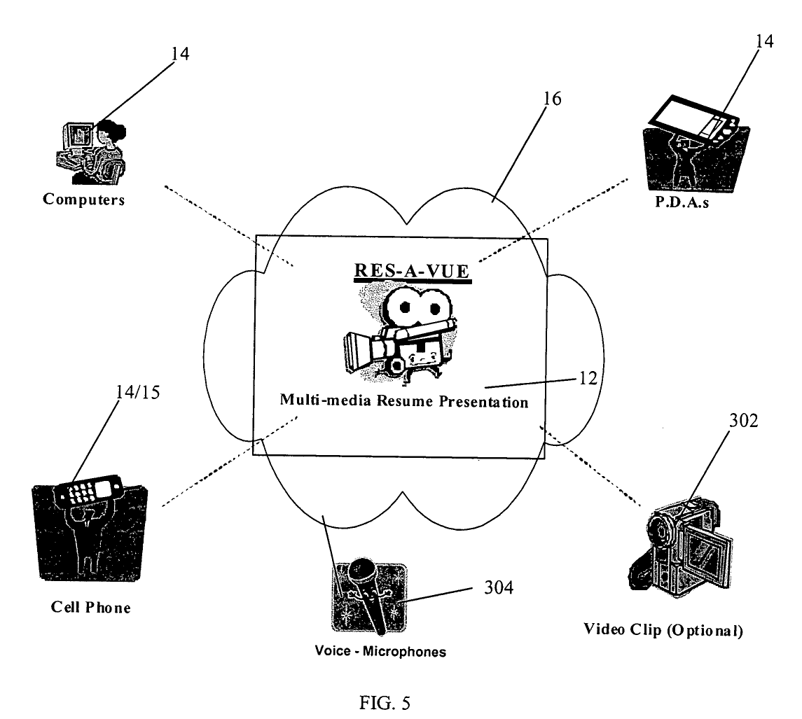

FIG. 5 is a diagram that illustrates an example hardware arrangement in connection with various devices and for providing and receiving multi-media presentations, including for resumes, in accordance with a preferred embodiment. Users are preferably provided with graphical screen controls, such as buttons, drop down lists, check boxes, radio buttons or the like, and select templates or other content to include in a multi-media presentation. In one embodiment, a user may use his or her telephone to call information processor, and, thereafter, speak content for a presentation that is preferably recorded and, thereafter, integrated with a multimedia presentation. In another embodiment, a video clip 302 is uploaded to information processor 12 by a respective user. Further, voice recording microphone 304 maybe used to record audio content. Thereafter, the clip 302 is provided, such as by e-mail or other convenient transfer, to a computer workstation 14, a PDA workstation 14 and/or a cellular telephone workstation 14 (or 15). Thus, in one embodiment, completed video clips, such as described in the '915 patent application, are uploaded to information processor 12 and, thereafter, available to various users associated with information processor 12.

Thus, users preferably access information processor 12 via the internet or other communication network and, via selections and interfaces provided by information processor 12, select or otherwise define multimedia presentations for use in connection with the teachings herein.

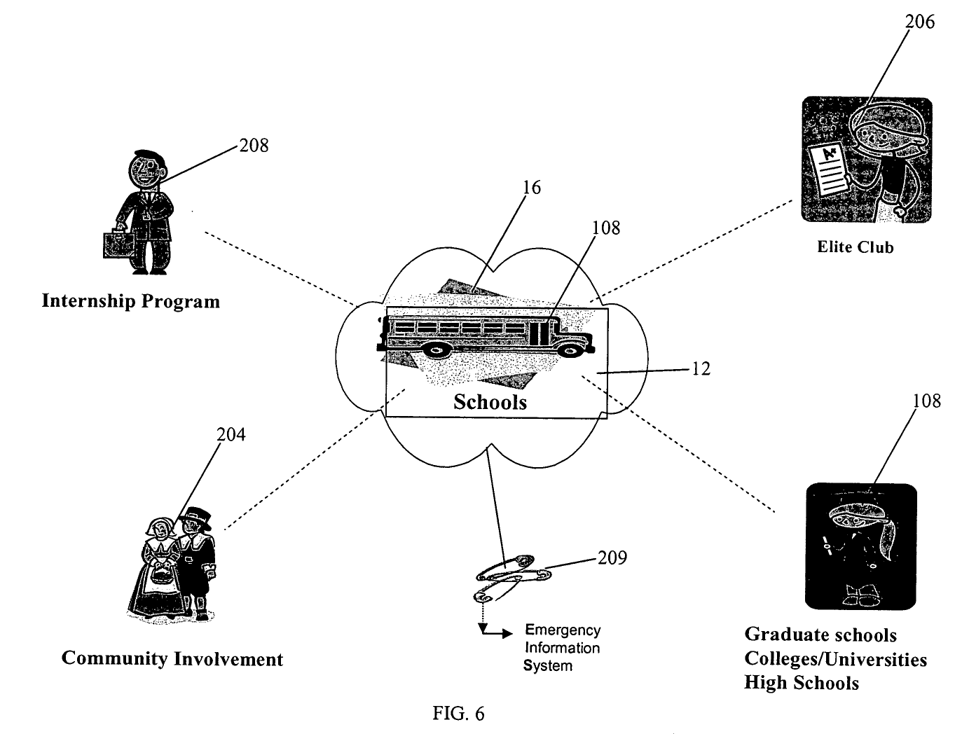

FIG. 6 is a diagram that illustrates programs and options available to schools 108 in accordance with a preferred embodiment. For example, schools 108 establish a communication session with information processor 12 and, thereafter, are provided selectable options associated with community involvement 204, elite clubs 206, internship programs 208, and emergency information system 209, such as described above with reference to FIG. 3. Schools 108 preferably comprise varying levels of education, including, for example, academic institutions associated with graduate schools, colleges/universities and high schools. Thus, using modules provided on information processor 12, schools 108 are able to promote students and locate potential employers for students, as well as to offer programs (e.g., internships or the like) for their students.

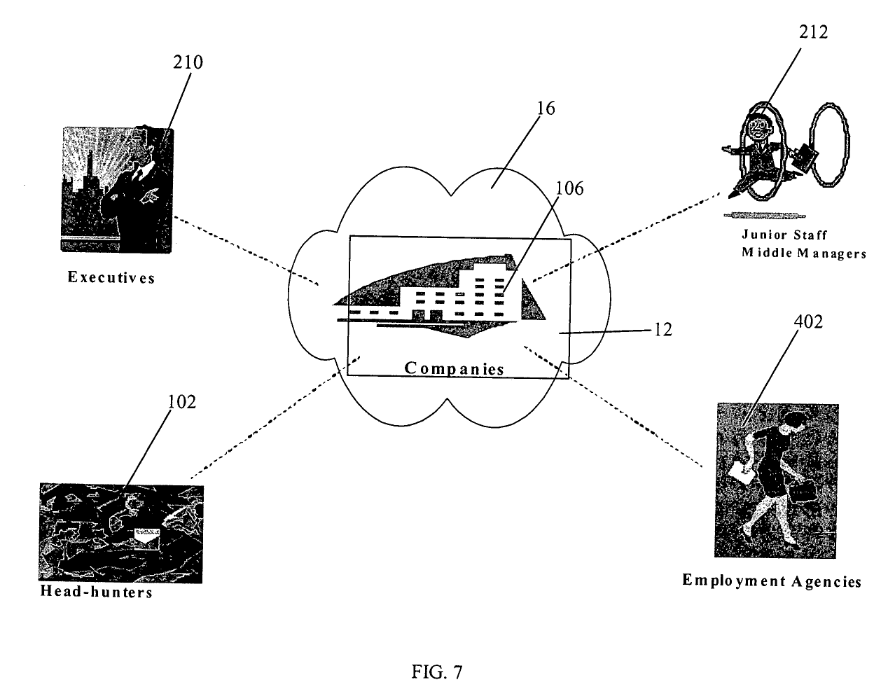

FIG. 7 is a diagram that illustrates parties and relationships available to companies 106 in accordance with a preferred embodiment. Companies 106 preferably access information processor 12 via communication network 16 for uploading and receiving content, and for communicating with parties associated therewith. As shown in FIG. 7, executives 210, management 212, and headhunters 102, including employment agencies 402, interface via information processor 12 and as described herein.

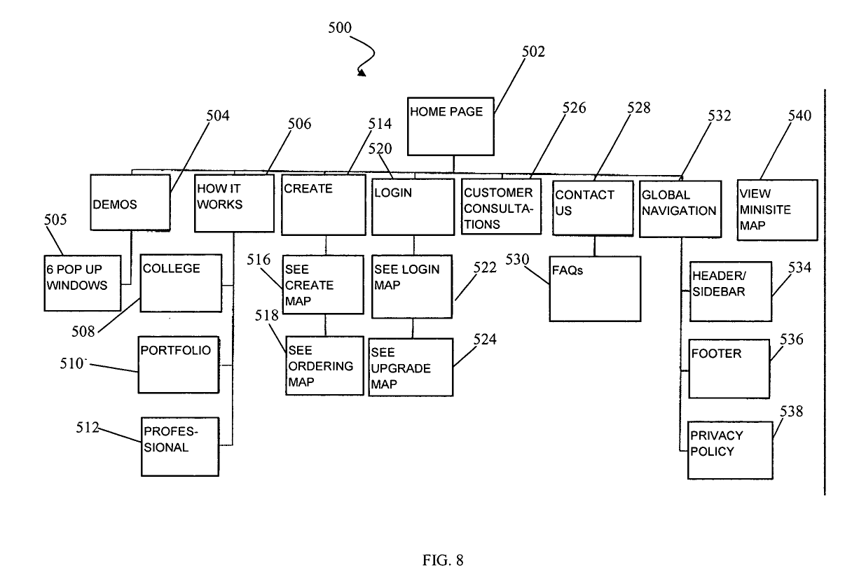

FIG. 8 is a block diagram that illustrates an example site map 500 associated with a web site provided by information processor 12 in accordance with a preferred embodiment. As will be appreciated by one skilled in the art, each of the blocks shown in FIG. 8 represent one or more web pages that comprise a web site. Block 502 represents an example internet home page that is provided to a user who establishes a communication session with information processor 12, for example, by entering WWW.RESAVUE.COM in the user's web browser address bar. Underneath block 502 are respective levels of web pages that are accessible to the user, for example, as the user makes selections (e.g., of hyperlinks) in home page 502.

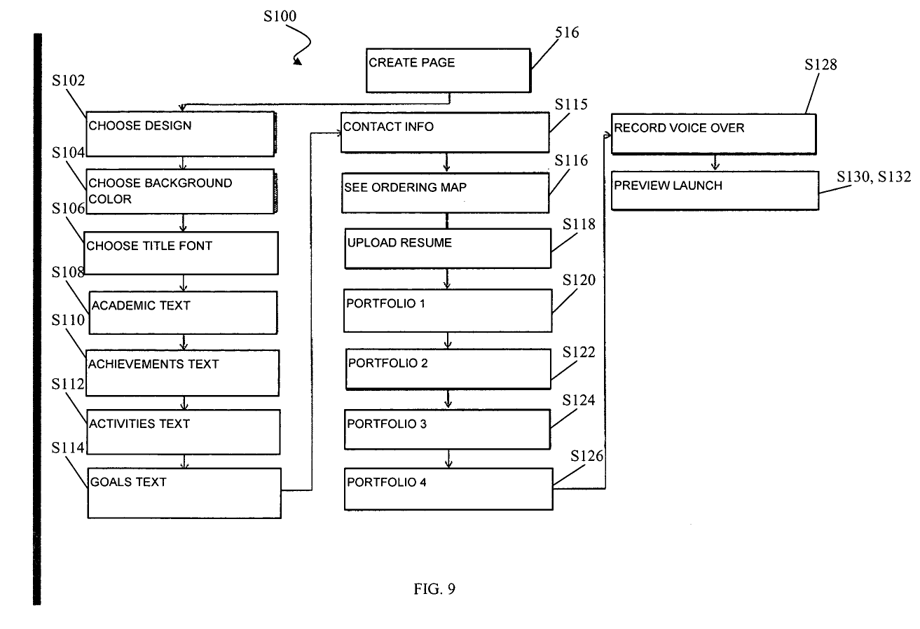

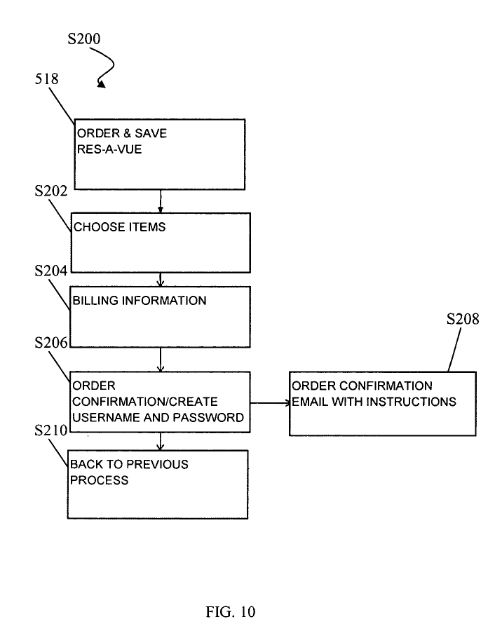

Continuing with reference to the site map 500 shown in FIG. 8, “Demos” page block 504 preferably provides the user with example multimedia presentations that were generated and/or otherwise available via information processor 12. In the example shown in FIG. 8, pop-up-windows 505 preferably demonstrate to the user various sample multimedia presentations. “How It Works” page block 506 represents a web page that provides instructional materials for a user, including, for example, associated with college materials 508, portfolio materials 510 and professional materials 512. Further, “Create” page block 514 represents one or more web pages that are provided to a user for creating a multimedia presentation in accordance with the teachings herein, including “Create Map” page block 516 (described below, with reference to FIG. 9), and “Ordering Map page block 518 (described below, with reference to FIG. 10).

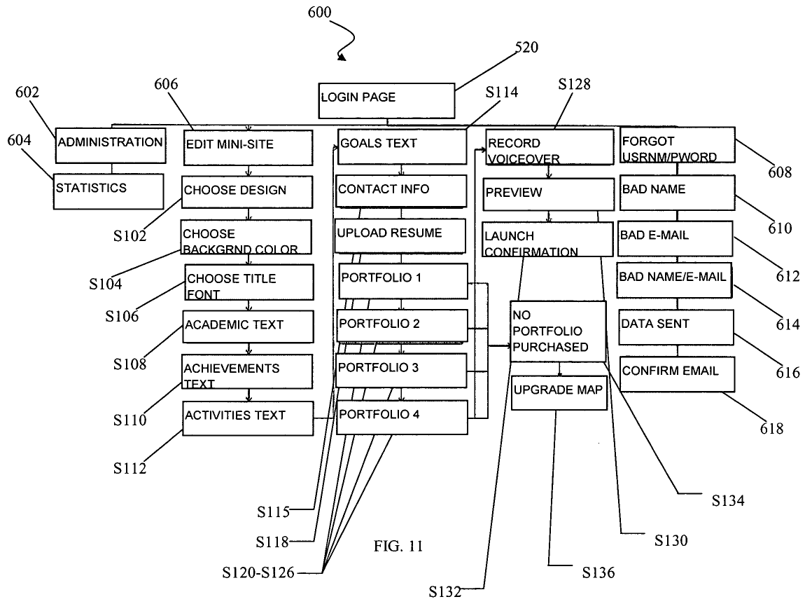

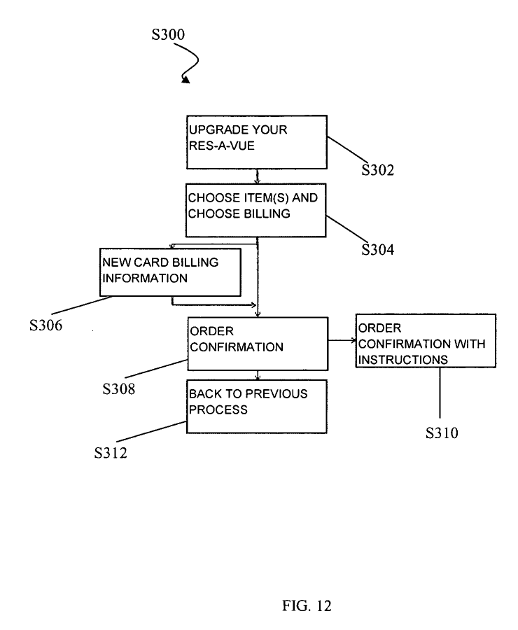

Continuing with reference to FIG. 8, “Login” page block 520 represents an example web page preferably provided to users to submit authorized user names and passwords to gain secure access to information processor 12. When selected, users are presented with a log in page, represented by “Login Map” page block 522 (described below, with reference to FIG. 11) and/or an upgrade account page, represented by “Upgrade Map” page block 524 (described below, with reference to FIG. 12). In addition, site map 500 includes “Consumer Consultations” page block 526 that provides, for example, telephone, on-line or other forms of personalized customized help for users. Further, site map 500 includes “Contact Us” page block 528 and Frequently Asked Questions “FAQ”) page block 530, that preferably provide information enabling a user to contact a proprietor of information processor 12 and to review other users' frequently asked questions, respectively, as known in the art.

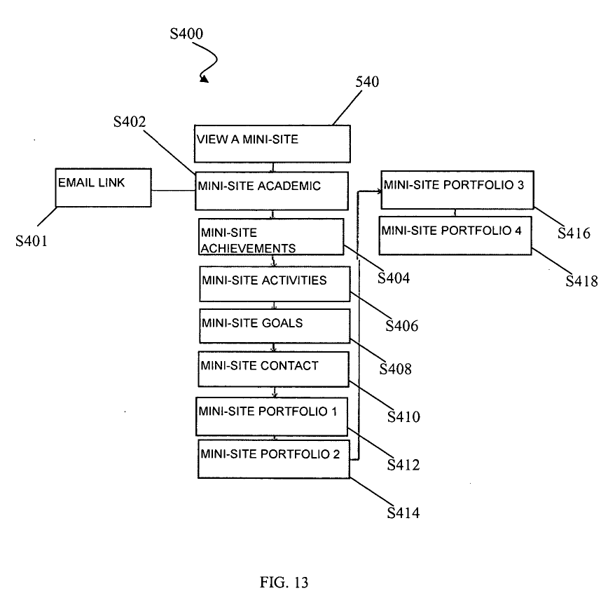

Continuing with reference to FIG. 8, “Global Navigation” page block 532 represents portions of a web page that provides, for example, convenient and quick access to various portions of a web page or web site. As shown in FIG. 8, “Header/Sidebar” block 534, “Footer” block 536 and “Privacy Policy” block 538 represent portions of a web page that include links or other forms of access to information and content. Furthermore, “View Minisite's Map” block 538 enables a user to view a multimedia presentation, and is described below with reference to FIG. 13.

FIG. 9 is a block diagram that illustrates example steps S100 associated with creating a multi-media presentation (516, FIG. 8) in accordance with a preferred embodiment. At step S102, the user preferably selects a design for the page. For example, and at step S104, a background color is chosen, and at step S106, a font choice is made for the title. At steps S108-S114, various categories of textual material are added, such as academic text, achievements text, activities text and goals text, respectively. At step S115, the user submits contact information for other users to use to contact the user. At step S116, the user selects an option for an “ordering map” 518 (FIG. 8), for example, to purchase features provided by information processor 12 and offered for sale by the proprietor thereof. Ordering map is described below, with reference to FIG. 10.

Continuing with reference to FIG. 9, steps S118-S126 regard uploading content to information processor 12, including resumes and portfolios. Preferably steps S120-S126 represent uploading a plurality of portfolios to information processor 12 to be included and stored for viewing by other users. For example, portfolios may be provided by students that represent various coursework that has been completed, while professionals may transmit portfolios that spawn years of the professionals' careers. Preferably, portfolios include, for example, architectural renderings, fashion designs, mechanical/electrical diagrams, real estate properties, video clips on any subject, such as introducing new or potential employees to geographic areas, talent or any subject, and preferably in an audio-visual format. Moreover, a teaching tool is further provided that presents arts programs to students in schools with low or no budgets allocations for cultural subjects.

Continuing with reference to FIG. 9, at step S128 the user preferably records or otherwise submits a voice over. For example, the user telephones information processor 12 and selects one or more touch-tone menu options that enable the user to access a voice recording option. Alternatively, the user uses his or her computer microphone or other device having digital voice recording capability and, thereafter, the user submits the voice over to information processor 12, and the voice over is automatically applied to the multi-media presentation. Thereafter, at step S130, the user selects a graphical screen control or other option and previews the multimedia presentation. Moreover, the user is provided with access to launch the multimedia content at step S132.

Preferably, after a user designs a multimedia presentation, the user is prompted to submit payment therefor. In this way, the proprietor of information processor 12 receives payment for providing the services described herein. FIG. 10 is a flow chart that illustrates example steps S200 associated with saving and ordering the multimedia content. Preferably, at step S202, items for purchase are selected and/or chosen by the user. Users can further opt to add thank you notes, simple or expanded portfolios, video clips or video resumes, or request a customized presentation,

Thereafter, at step S204, billing information, such as credit card information, contact information including e-mail address, or the like is provided by the user and submitted to information processor 12. At step S206, after payment is duly received, an order confirmation is preferably sent to the user and received thereby, and the user selects a user name and password for secure access to information processor 12. Alternatively, a user name and password is automatically generated for the user and the user can, at some future time, modify the user name, the password or both. At step S208, the user is prompted to check his or her e-mail for confirmation and instructions for how to send the multimedia content to various sources, as well as to define preferences, such as tracking and sending reminders, as described herein. Thereafter, at step S210, the process branches back to a previous process, such as to upload a resume.

Once a user has committed to ordering and purchasing multimedia content services provided in connection with the teachings herein, the user is able to securely access information processor 12, such as by submitting a valid user name and password and to effectively log in and use extended features provided via information processor 12.

FIG. 11 illustrates example options 600 and corresponding steps associated with authorized users accessing information processor 12 and, accordingly, selecting options for, among other things, generating multimedia presentations and storing the presentations on information processor 12. As shown in FIG. 9, “Administration” options 602 are preferably available for a user to manage his or her multimedia content and/or corresponding internet web site. For example, “Statistics” option 604 is preferably provided for a user to review statistics corresponding to the user's multimedia content and/or corresponding internet web page. For example, a user can review the number of times and amount of time spent reviewing a presentation, the number of times the user's web page has been accessed, or the number of times a resume or portfolio has been downloaded.

In addition to Administration options, authorized users who are registered with information processor 12 preferably can select steps associated with “Editing a Mini-Site” 606 or other multimedia presentation in accordance with the teachings herein. In a preferred embodiment, the steps (S102-S132) provided in connection with option 606 are the same as shown and described above with reference to FIG. 9. For example, users are presented with graphical screen controls to design a multimedia presentation, as well as to upload content, record a voice over, review and launch the presentation. In addition, step 134 associated with users who have not purchased an option to upload and present portfolios, are provided with “Upgrade Map” option 134 that entitles users to upgrade access and features associated with information processor 12. Steps associated with option 134 are described below, with reference to FIG. 12.

Continuing with reference to FIG. 11, occasionally users attempt to access restricted areas of information processor and are otherwise refused access. For example, a user may select an option, “Forgot User Name/Password” 608, in case the user has lost, forgotten or otherwise is without his or her user name and password. This option may be displayed to a user in case, for example, the user submits an incorrect user name 610, an incorrect or invalid e-mail address 612 or an invalid combination of user name and e-mail address 614. Thereafter, the user preferably submits correction data 616, and, thereafter, receives a confirmation e-mail 618 when the user is recognized by information processor 12 as an authorized user.

Initially, most candidates elect a basic, low-cost subscription or that provided by their university for several reasons. The presentations can be created, personally and on-line either free or inexpensively, and very quickly. Following initial uses, however, users desire robust options and, accordingly will elect to upgrade their accounts. FIG. 12 is a flowchart that illustrates example steps S300 that are associated with upgrading a user account provided in accordance with information processor 12. After the user selects, at step S302, an option to upgrade the user's account, the user selects items for inclusion in the account upgrade, and identifies corresponding billing options (step S304). A user optionally selects a new credit card billing information (step S306), and receives confirmation that an account has been upgraded (step S308). The confirmation preferably includes a confirmation via e-mail with instructions how to implement the upgraded options (step S310). Thereafter, at step S312, the process branches back to a previous process, such as to upload a portfolio.

FIG. 13 is a flow chart that illustrates example steps S400 associated with Viewing a MiniSite (e.g., a multi-media presentation) 540. At step S401, in accordance with a preferred embodiment, a link to a user's multimedia presentation is preferably e-mailed to a recipient. Of course, one skilled in the art will recognize that other ways of delivering multimedia content to a user are envisioned herein, including e-mailing the multimedia presentation itself. Thereafter, at steps S402-S414, respective portions of multimedia content and/or a corresponding web page are displayed to the recipient. For example, the recipient is able to navigate mini-site academics (step S402), Achievements (S404), Activities (S406), Goals (S408), Contact Information (S410), Portfolios 1-4 (S412-S416).

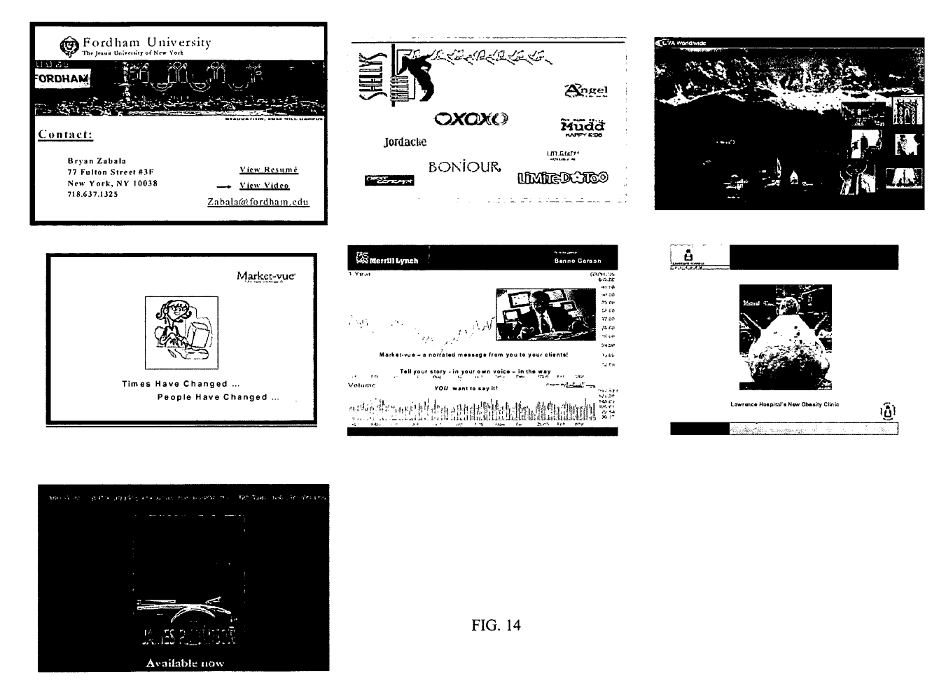

FIG. 14 illustrates examples web pages and multimedia presentations generated and distributed in accordance with a preferred embodiment.

Thus, the parties, relationships, interactions and features described herein provide efficient and dramatic improvements over the prior art. Recruiters save time by assessing a person behind a printed page, as the multimedia presentations serve as preliminary interviews. Moreover, interactive e-mail features quicken setting and confirming appointments, and candidates can be quickly and easily evaluated for special positions, while applications of no interest are quickly deleted. Moreover, piles of paper typically associated are eliminated

Moreover, using the systems and methods described herein, company messages reach intended audiences in a successful and economic fashion. The interactive nature of the teachings herein is delivered, for example, via college web sites, through e-mail or transmitted to cellular telephones with internet access. This gives companies an advantage of telling their stories to many parties, from students to seasoned employees looking to make a change. Professionals, for example, access a professional profile section for a nominal fee, and are able cross-reference a section for colleges in the event to satisfy corporate regional needs or specialties at no extra charge.

Although the present invention has been described in relation to particular embodiments thereof, many other variations and modifications and other uses will become apparent to those skilled in the art. Military recruitment for, for example, the United States Marine Corps, United States Army, can take advantage of the systems and methods described herein. Further, the invention is applicable for members of Wall Street, as trends are conveyed, such as in the stock market, insurance or banking businesses, real-estate development, as well as locally, nationally and internationally. A message is transmitted to a bevy of clients and is easily modifiable by simply, for example, dialing a toll-free access number to update ideas or using a computer equipped with a microphone or other device.

Other industries that can benefit by the teachings herein include, for example, health care institution, publishing houses, as well as employment agencies, schools, companies and headhunters.

It is preferred, therefore, that the present invention be limited not by the specific disclosure herein.

What is claimed is:

1. A method for creating, displaying and searching for a multimedia presentation using a communication network, the method comprising:
storing on an information processor multimedia presentation modules that enable users to select options associated with the multimedia presentation;
hosting an internet web site on the information processor, wherein the internet web site includes restricted and unrestricted access thereto;
defining by a user of the information processor a multimedia presentation by selecting a template provided by an information processor;
defining by the user at least image and text components to be included in the multimedia presentation, wherein the defining includes selecting from the information processor or uploading to the information processor the at least image and textual components;
generating by the information processor the multimedia presentation;
storing the multimedia presentation on the information processor;
transmitting a message to a recipient enabling the recipient to access the multimedia presentation, wherein the multimedia presentation is accessible using at least one of a web browser software application, an e-mail software application or a cellular telephone; and
providing an interface on the information processor enabling the user or other users to search for, locate and view the multimedia presentation.

2. The method of claim 1, further comprising assigning the user storage space on the information processor for the storing of the multimedia presentation.

3. The method of claim 2, wherein the storage space is identified by a uniform resource locator enabling the other users to view the multimedia presentation using a web browser.

4. The method of claim 1, further comprising defining varying access levels to the user, wherein the user is charged a respective fee for each access level.

5. The method of claim 4, wherein the access levels include an entry level, an intermediate level and an executive level.

6. The method of claim 1, further comprising providing selections to the user for formatting the image and text components.

7. The method of claim 6, wherein the formatting includes selecting options for one or more of a layout design, a background color, a title font, academic accomplishments, achievements, activities, goals, contact information, portfolios.

8. The method of claim 1, further comprising providing a voice over to the information processor.

9. The method of claim 8, wherein the voice over is provided using a digital voice recorder, a computer equipped with a microphone or other device, and uploaded by the user to the information processor as an electronic voice over file.

10. The method of claim 8, wherein the voice over is dictated over a telephone to the information processor, stored on the information processor, and added to the multimedia presentation automatically by the information processor.

11. A system for creating, displaying and searching for a multimedia presentation using a communication network, the system comprising:
an information processor that stores multimedia presentation modules enabling users to select options associated with the multimedia presentation;
an internet web site hosted on the information processor, wherein the internet web site includes restricted and unrestricted access thereto;
a plurality templates stored on the information processor for defining by a user of the information processor a multimedia presentation by selecting at least one template of the templates;
image and text components defined by the user to be included in the multimedia presentation, wherein the image and text components are selected from the information processor or uploaded to the information processor by the user;
a generating module operable to generate the multimedia presentation, wherein the multimedia presentation comprises the image and text components
a storage module operable to store the multimedia presentation on the information processor;
a message transmission module operable to transmit a message to a recipient enabling the recipient to access the multimedia presentation, wherein the multimedia presentation is accessible using at least one of a web browser software application, an e-mail software application or a cellular telephone; and
a search engine on the information processor enabling the user or other users to search for, locate and view the multimedia presentation.

12. The system of claim 11, further comprising storage space assigned to the user and located on the information processor for the storing of the multimedia presentation.

13. The system of claim 12, wherein the storage space is identified by a uniform resource locator enabling the other users to view the multimedia presentation using a web browser.

14. The system of claim 11, further comprising varying access levels to the user, wherein the user is charged a respective fee for each access level.

15. The system of claim 14, wherein the access levels include an entry level, an intermediate level and an executive level.

16. The system of claim 11, further comprising selections to the user for formatting the image and text components.

17. The system of claim 16, wherein the formatting includes selecting options for one or more of a layout design, a background color, a title font, academic accomplishments, achievements, activities, goals, contact information, portfolios.

18. The system of claim 11, further comprising a voice over that is provided to the information processor.

19. The system of claim 18, wherein the voice over is provided using a digital voice recorder or a computer equipped with a microphone or other device, and uploaded by the user to the information processor as a electronic voice over file.

20. The system of claim 18, wherein the voice over is dictated over a telephone to the information processor, stored on the information processor, and added to the multimedia presentation automatically by the information processor.
